(19) United States
(12) Patent Application Publication
(10) Pub. No.: US 2011/0032091 A1
(43) Pub. Date: Feb. 10, 2011

(54) TOUCH SCREEN DEVICE

(76) Inventors: Dong Sun PARK, Seoul (KR); Yeon Ho Son, Gyunggi-do (KR); Jae Kyung Kim, Gyunggi-do (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/565,674

(22) Filed: Sep. 23, 2009

(30) Foreign Application Priority Data
Aug. 7, 2009 (KR) 10-2009-0072943

(51) Int. Cl. G08B 6/00

(52) U.S. Cl. 340/407.2; 345/173

(57) ABSTRACT

Disclosed herein is a touch screen device. The touch screen device includes a touch display module having a touch screen panel and an image display unit coupled to the lower surface of the touch screen panel. A plate is attached at a first side thereof to a portion around an edge of a lower surface of the image display unit, and is stepped to extend inwards in a horizontal direction. A vibration generating means is mounted on a horizontally extending portion of the plate in such a way as to be spaced apart from the image display unit. An elastic member is attached to the lower surface of the plate. The touch screen device is applicable to the touch display module, is capable of improving the sensation of vibrations applied to the touch screen panel and controlling the frequency range of vibrations applied to a touch screen panel.

### CROSS REFERENCE TO RELATED APPLICATION(S)

This application claims the benefit of Korean Patent Application No. 10-2009-0072943, filed on Aug. 7, 2009, entitled “Touch Screen Device”, which is hereby incorporated by reference in its entirety into this application.

### BACKGROUND OF THE INVENTION

1. Technical Field

The present invention relates to a touch screen device.

2. Description of the Related Art

Recently, as user demand for the convenient use of electronic products increases, a touch screen which performs input by touching the screen has been universalized. A touch screen device includes a concept which reflects a user's intuitive experience with an interface and diversifies feedback, in addition to including the concept of inputting by touching the device.

The touch screen device is advantageous in that space is saved and convenience is achieved, manipulability is improved, it is easy to change a specification, the valuation by consumers is high, and it is easy to be operated in conjunction with IT equipment. Owing to these advantages, the touch screen has been widely used in a variety of fields including the fields of industry, traffic, service, medical service and mobile-equipment.

In the general touch screen device, a transparent touch panel is placed to be in close contact with an image display device, such as an LCD which displays an image. When a user presses and manipulates the touch panel while seeing the image through the touch panel, a vibration generating means applies the sensation of vibration to the touch panel, thus transmitting the sensation of vibration to the user.

FIG. 1 illustrates a conventional touch screen device.

As shown in FIG. 1, the conventional touch screen device is constructed so that an image display unit 20 is attached to the lower surface of a touch screen panel 10, and a vibration generating means 30 is located between the touch screen panel 10 and the image display unit 20. The attached components are mounted to a component setting unit 40.

However, the conventional touch screen device is problematic in that the vibration generating means 30 is attached between the touch screen panel 10 and the image display unit 20, so that the touch screen panel 10 and the image display unit 20 are attached to each other while leaving a gap therebetween, and thereby impact strength of the touch screen device is reduced and the transmission accuracy of an interface for a user becomes poor because of the gap between the touch screen panel 10 serving as an input unit and the image display unit 20. Moreover, since the touch screen panel 10 and the image display unit 20 are separated from each other, a lot of time and cost are required to couple the touch screen panel 10 with the image display unit 20, thus decreasing productivity.

Meanwhile, in order to transmit the optimum sensation of vibration to a user while the touch screen device is being used, vibrations which are transmitted through the touch screen panel 10 to the user finally must be within a predetermined frequency range. The conventional touch screen device is problematic in that since the vibration generating means 30 is directly attached to the lower surface of the touch screen panel 10, it is difficult to control the vibration generating means 30. Further, since the first vibrational frequency generated from the vibration generating means 30 is usually higher than a frequency range which is to be transmitted to a user, it is required to correct the frequency of the first vibration. However, the conventional touch screen device constructed as described above has a large difficulty in correcting this frequency.

### SUMMARY OF THE INVENTION

The present invention has been made in an effort to provide a touch screen device, which is applicable to a touch display module and is capable of improving the sensation of vibrations applied to a touch screen panel.

Further, the present invention has been made in an effort to provide a touch screen device, which changes the shape of a plate serving as a diaphragm, thus controlling the frequency range of vibrations applied to a touch screen panel.

A touch screen device according to an embodiment of the present invention includes a touch display module having a touch screen panel and an image display unit coupled to a lower surface of the touch screen panel. At least one plate is attached at a first side thereof to a portion around an edge of a lower surface of the image display unit, and is stepped to extend inwards in a horizontal direction. A vibration generating means is mounted on a horizontally extending portion of the plate in such a way as to be spaced apart from the image display unit. An elastic member is attached to the lower surface of the plate.

The plate may comprise one or more pairs of plates which are mounted to lower surfaces of portions around lengthwise edges or widthwise edges of the image display unit.

Further, the plate may include a first plate part having a shape of a frame which is attached to the portion around the edge of the lower surface of the image display unit and is open therein, a stepped part bent downwards from the first plate part, and a second plate part bent from the stepped part in such a way as to extend inwards in a horizontal direction.

Further, the plate may include an outer plate part having a shape of a frame which is attached to the portion around the edge of the lower surface the image display unit and is open therein, a bent plate part bent downwards from the outer plate part, and an inner plate part bent from the bent plate part in such a way as to extend inwards in a horizontal direction.

The stepped part of the plate may be bent downwards from an end of the plate in such a way as to extend vertically or obliquely.

The vibration generating means may be a piezoelectric actuator or polymer actuator which is contracted or extended in a lengthwise direction when external power is applied so as to apply vibrations to the touch screen panel.

Further, the elastic member may be attached to a lower surface of a predetermined portion of the plate in such a way as to protrude downwards from the plate, thus causing the plate to be spaced apart from a component setting unit.

Further, the elastic member may be made of a rubber material.

The elastic member attached to a lower surface of a predetermined portion of the plate may be mounted to the component setting unit, and the horizontally extending portion of the plate may be received in an opening formed in the component setting unit, thus causing the plate to be spaced apart from the component setting unit.

A touch screen device according to another embodiment of the present invention includes a touch display module having a touch screen panel and an image display unit coupled to a lower surface of the touch screen panel. A main plate is mounted to a lower surface of the image display unit. At least one strip is formed inside an edge of the main plate in such a way that both ends thereof are connected to the main plate and a side thereof is spaced apart from the main plate. A vibration generating means is mounted on an upper surface of the strip.

The touch screen device may further include an elastic member attached to an edge of the main plate.

The strip may include an inclined strip part inclined downwards from the main plate, and a horizontal strip part extending inwards from the inclined strip part in a horizontal direction.

The strip may comprise a plurality of strips provided on the main plate.

Further, the main plate may have the shape of a frame which is open therein.

The strip may comprise one or more pairs of strips which are provided inside the edge of the main plate in such a way as to face each other, and the facing strips may be coupled to each other via a coupling strip.

### BRIEF DESCRIPTION OF THE DRAWINGS

FIG. 1 is an exploded perspective view illustrating a conventional touch screen device;

FIG. 2 is a schematic sectional view illustrating a touch screen device according to a first embodiment of the present invention;

FIG. 3 is an exploded perspective view illustrating the touch screen device of FIG. 2;

FIG. 4 is an exploded perspective view illustrating a touch screen device according to a second embodiment of the present invention;

FIG. 5 is an exploded perspective view illustrating a touch screen device according to a third embodiment of the present invention;

FIG. 6 is a sectional view illustrating a touch screen device according to a fourth embodiment of the present invention;

FIG. 7 is a sectional view illustrating a touch screen device according to a fifth embodiment of the present invention;

FIG. 8 is a perspective view illustrating part of the touch screen device shown in FIG. 7;

FIG. 9 is an exploded perspective view illustrating a vibration generating means, a plate, and an elastic member of a touch screen device according to a sixth embodiment of the present invention;

FIGS. 10A and 10B are views illustrating a vibration generating means, a plate, and an elastic member of a touch screen device according to a seventh embodiment of the present invention;

FIG. 11 is an exploded perspective view illustrating a vibration generating means, a plate, and an elastic member of a touch screen device according to an eighth embodiment of the present invention;

FIG. 12 is an exploded perspective view illustrating a vibration generating means, a plate, and an elastic member of a touch screen device according to a ninth embodiment of the present invention; and

FIG. 13 is an exploded perspective view illustrating a vibration generating means, a plate, and an elastic member of a touch screen device according to a tenth embodiment of the present invention.

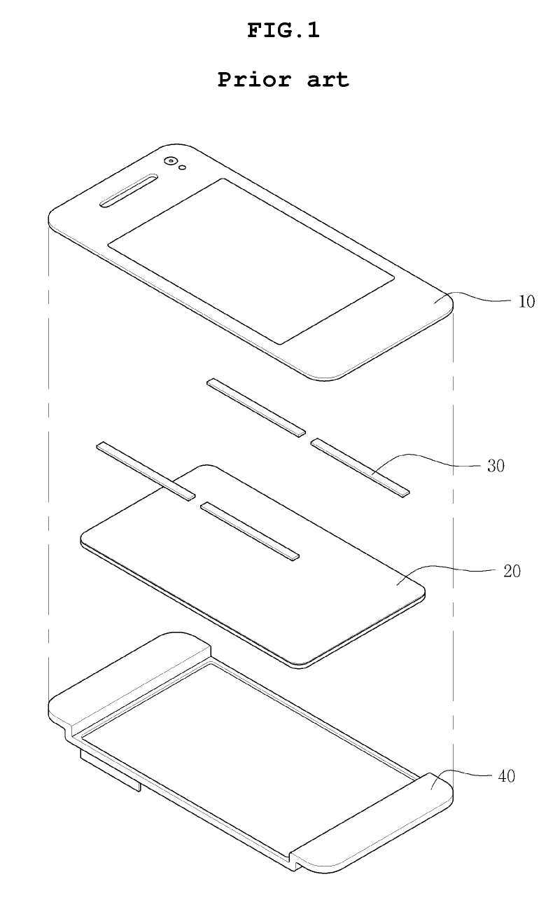

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. Herein, the same reference numerals are used throughout the different drawings to designate the same components. Further, when it is determined that the detailed description of the known art related to the present invention may obscure the gist of the present invention, the detailed description thereof will be omitted.

Hereinafter, the preferred embodiments of the present invention will be described in detail with reference to the accompanying drawings.

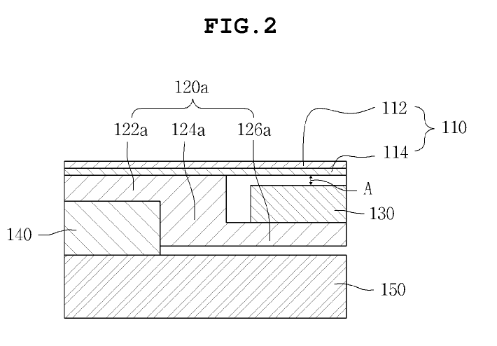

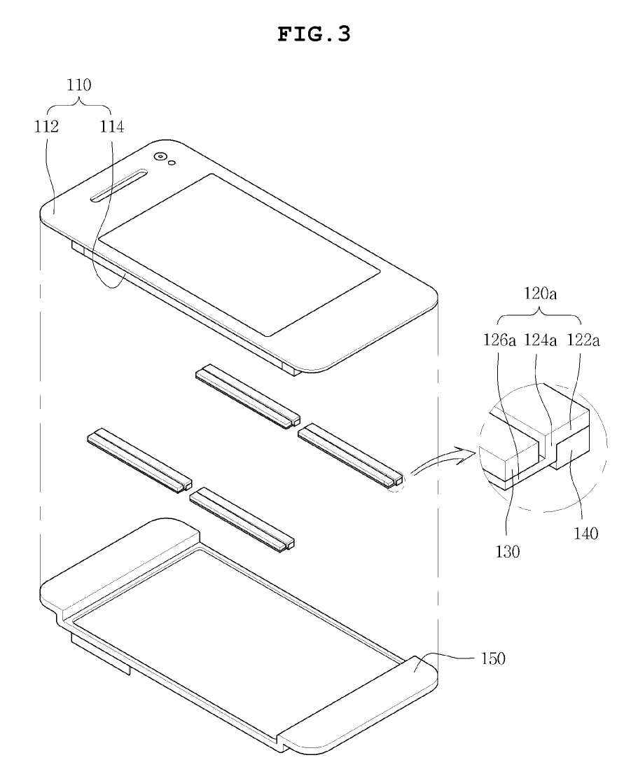

FIG. 2 is a schematic sectional view illustrating a touch screen device according to a first embodiment of the present invention, and FIG. 3 is an exploded perspective view illustrating the touch screen device of FIG. 2

As shown in FIGS. 2 and 3, the touch screen device according to this embodiment includes a touch display module 110, a plate 120a, a vibration generating means 130, and an elastic member 140. These components are set in and fastened to a component setting unit 150.

The touch display module 110 is the means for inputting and displaying a user's request by pressing and manipulating a touch screen panel 112 while viewing an image displayed on an image display unit 114. The touch display module 110 is constructed so that the touch screen panel 112 and the image display unit 114 such as an LCD are integrally coupled to each other. Such a touch display module 110 has the advantages of being of high productivity and high strength against impact, in comparison with a conventional touch display module which is constructed so that the touch screen panel 112 and the image display unit 114 are separated from each other.

Here, the touch screen panel 112 has transparency and flexibility, thus serving as a surface through which a signal may be input and which is pressed and manipulated while a user is seeing an image displayed on the image display unit 114. For example, the touch screen panel 112 may have the structure of a rectangle which is long in a lengthwise direction.

For example, the touch screen panel 112 is formed by layering an outer film, an Indium Tin Oxide (ITO) film, and a base film

The outer film is mounted to the front of a mobile communication terminal, and is divided into a viewing area on which a user may do input by touching and a dead space area which is formed around the viewing area. Meanwhile, the outer film is made of a transparent film material, such as Poly Ethylene Terephthalate (PET), to permit the screen of the image display unit 114 to be seen through.

Although not shown in detail in the drawings, the ITO film comprises two upper and lower layers, with a dot spacer provided between the upper and lower layers to maintain a predetermined space therebetween. A membrane electrode which has a conductive X-axis pattern and Y-axis pattern along an edge is provided on each layer. The X-axis pattern and the Y-axis pattern are electrically insulated from each other by an insulator (not shown). The membrane electrode is exposed through an FPC cable to the outside of the ITO film so as to be electrically connected to a mobile terminal.

The base film functions to support the whole touch screen panel, and may comprise a glass substrate having superior transmissibility and touch response speed.

The plate 120a provides a space for mounting the vibration generating means 130, and also serves as a diaphragm which transmits vibrations from the vibration generating means 130 to the touch display module 110. The plate 120a is stepped and attached at one side thereof to a portion around the edge of the lower surface of the image display unit 114 in such a way as to extend inwards in a horizontal direction. Thus, the other side of the plate 120a is spaced apart from the image display unit 114.

In this embodiment, one or more pairs of plates 120a are mounted to portions around lengthwise edges and/or widthwise edges of the lower surface of the image display unit 114 in such a way as to face each other. Here, the plates 120a are separated from each other.

The plate 120a includes an outer plate part 122a which is attached to a portion around the edge of the lower surface of the image display unit 114, a bent plate part 124a which is bent downwards from the inner end of the outer plate part 122a to extend in a vertical direction, and an inner plate part 126a which is bent from the bent plate part 124a to extend inwards in a horizontal direction.

Since the inner plate part 126a is spaced apart from the image display unit 114 owing to the bent plate part 124a, a space for mounting the vibration generating means 130 is provided above the inner plate part 126a. Preferably, a spacing distance between the inner plate part 126a and the image display unit 114 is adjusted so that the vibration generating means 130 mounted on the inner plate part 126a is also spaced apart from the image display unit 114 by a predetermined interval, thus defining a vibration generating space A.

In the present invention, since the vibration generating means 130 placed above the inner plate part 126a is spaced apart from the image display unit 114 by the vibration generating space A, the generated vibrations are transmitted sequentially through the inner plate part 126a, the bent plate part 124a and the outer plate part 122a to the touch display module 110.

That is, according to the present invention, vibrations generated from the vibration generating means 130 are transmitted via the plate 120a serving as the diaphragm. Thus, the frequency range of the vibrations transmitted to the touch display module 110 can be controlled by adjusting the shape, length and thickness of the plate 120a, the bent angle of the bent plate part 124a, the mounted state of the vibration generating means 130, and the size of the vibration generating space A. Such a vibration transmitting structure is advantageous in that it is easier to adjust the frequency range of the vibrations, in comparison with a conventional structure wherein the vibration generating means 130 is directly attached to the image display unit 114.

The vibration generating means 130 generates vibrations and applies the vibrations to the touch display module 110. The vibration generating means 130 is provided on the inner plate part 126a in such a way as to be spaced apart from the image display unit 114.

Here, a piezoelectric or polymer actuator which is contracted or expanded in a lengthwise direction by external power to apply the sensation of vibrations or a liner vibration motor may be used as the vibration generating means 130 for generating vibrations.

The elastic member 140 maximizes the transmission of vibrations to the touch display module 110, minimizes the transmission of vibrations to the component setting unit 150, and improves the reliability of the touch screen device by absorbing shocks when the device is dropped. The elastic member 140 is attached to the lower surface of the plate 120a.

If the component setting unit 150 and the plate 120a are in direct contact with each other, vibrations which are transmitted from the vibration generating means 130 to the plate 120a may be dispersed and transmitted to the component setting unit 150. In order to prevent the transmission of vibrations to the component setting unit 150, the elastic member 140 is attached to the lower surface of the plate 120a in such a way as to protrude downwards from the lower surface of the plate 120a. That is, the elastic member 140 is interposed between the plate 120a and the component setting unit 150, thus preventing the plate 120a and the component setting unit 150 from being in direct contact with each other.

Meanwhile, in order to minimize an increase in thickness of the touch screen device resulting from the use of the elastic member 140, the elastic member 140 is preferably attached to the lower surface of the outer plate part 122a in such a way as to protrude downwards from the inner plate 126a, thus allowing the thickness of the touch screen device to be compensated for by the height of the bent plate part 124a.

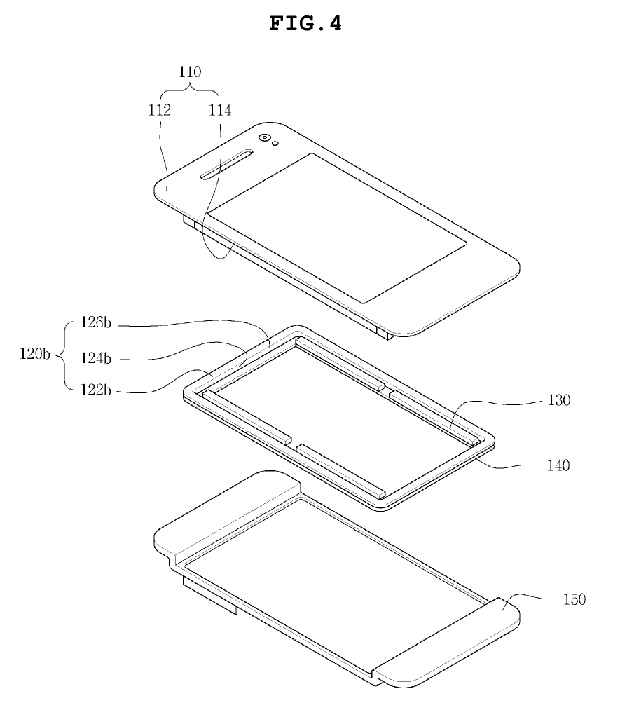

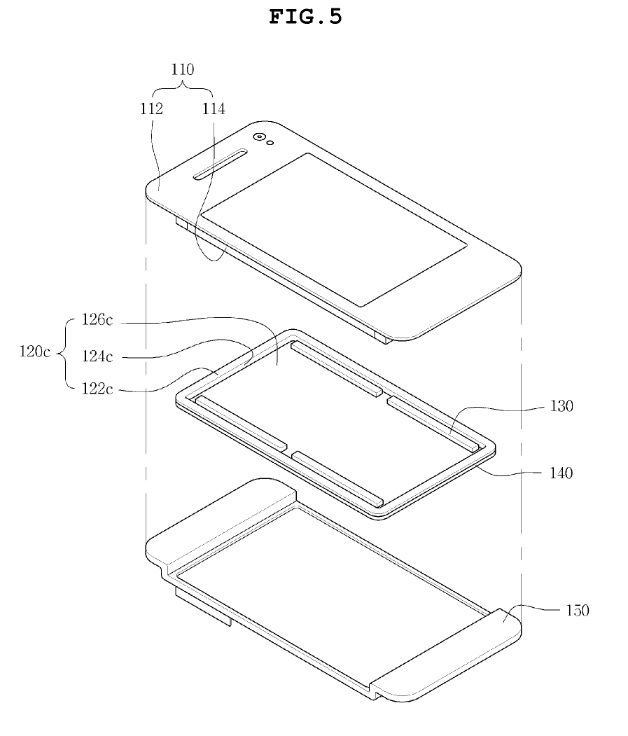

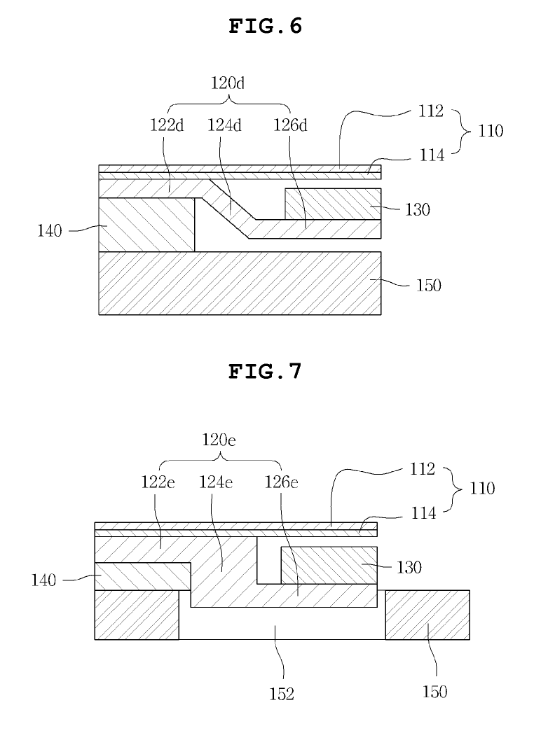

FIGS. 4 and 5 are exploded perspective view illustrating touch screen devices according to second and third embodiments of the present invention, and FIG. 6 is a sectional view illustrating a touch screen device according to a fourth embodiment of the present invention. Since the touch screen devices of FIGS. 4 to 6 are similar to the touch screen device of the first embodiment except for the shapes of plates 120b, 120c and 120d, the duplicate description thereof will be omitted.

First, as shown in FIG. 4, in the touch screen device according to the second embodiment of the present invention, the plate 120b has the shape of an integrated frame so as to improve assemblability. In detail, the plate 120b includes an outer plate part 122b having the shape of a frame (e.g., a rectangular shape) which is attached to the lower surface of the edge of the image display unit 114 and is open therein, a bent plate part 124b which is bent downwards from the inner end of the outer plate part 122b in such a way as to extend in a vertical direction, and an inner plate part 126b having the shape of a frame which is bent from the bent plate part 124b in such a way as to extend inwards in a horizontal direction and is open therein.

Next, as shown in FIG. 5, the touch screen device according to the third embodiment of the present invention is constructed so that a plate 120c has an integrated structure and is closed therein. In detail, the plate 120c includes an outer plate part 122c, a bent plate part 124c and an inner plate part 126c. The outer plate part 122c has the shape of a frame which is attached to the lower surface of the edge of the image display unit 114 and is open therein. The bent plate part 124c is bent downwards from the inner end of the outer plate part 122c in such a way as to extend in a vertical direction. The inner plate part 126c has the shape of a plate which is bent inwards from the bent plate part 124c in such a way as to extend in a horizontal direction. Here, the inner plate part 126c has the shape of the plate, so that the whole portion of the inner plate part 126c can serve as a diaphragm, and the vibration generating means 130 can be arranged on the inner plate part 126c with an increased degree of freedom.

Further, as shown in FIG. 6, the touch screen device according to the fourth embodiment of the present invention is constructed so that a bent plate part 124d of a plate 120d is inclined. In detail, the plate 120d includes an outer plate part 122d, the bent plate part 124d, and an inner plate part 126d. The outer plate part 122d is attached to the lower surface of the edge of the image display unit 114. The bent plate part 124d is bent downwards from the inner end of the outer plate part 122d in such a way as to be inclined. The inner plate part 126d is bent from the bent plate part 124d in such a way as to extend to inwards in a horizontal direction.

As described above, the frequency range of vibrations transmitted through the plate 120d can be controlled through a structural change which is achieved by adjusting the bent angle of the bent plate part 124d.

Meanwhile, the plate 120d of the touch screen device according to this embodiment may comprise a plurality of separate structures (see FIG. 3), an integrated structure which is open therein (see FIG. 4), or an integrated structure which is closed therein (see FIG. 5).

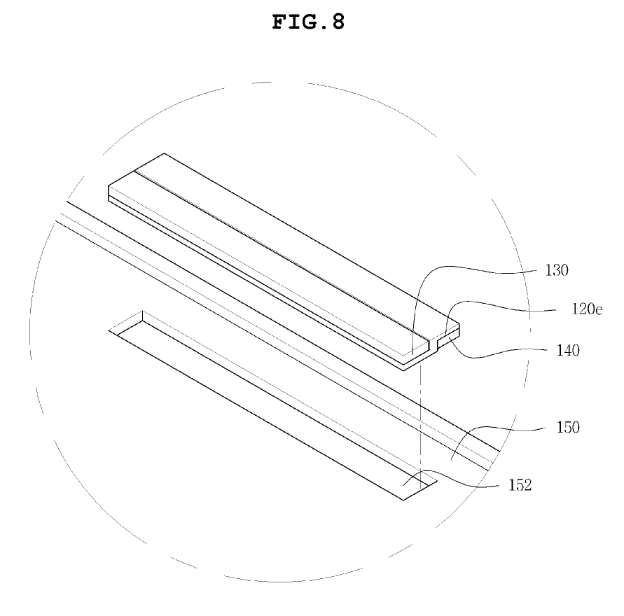

FIG. 7 is a sectional view illustrating a touch screen device according to a fifth embodiment of the present invention, and FIG. 8 is a perspective view illustrating part of the touch screen device shown in FIG. 7. As shown in FIGS. 7 and 8, the touch screen device according to this embodiment is similar to the touch screen device of FIGS. 2 and 3 except for the size of an elastic member 140, the shape of a component setting unit 150 and the arrangement of a plate 120e, duplicate description of similar parts will be omitted herein.

As shown in FIGS. 7 and 8, the touch screen device according to this embodiment prevents a plate 120e and a component setting unit 150 from coming into direct contact with each other, and includes an opening 152 in the component setting unit 150 to accommodate at least part of the plate 120e for the purpose of saving space.

In detail, the plate 120e has the same structure as the plate 120a of FIG. 2 except that the elastic member 140 is attached to the lower surface of an outer plate part 122e in such a way that the elastic member 140 does not protrude downwards from an inner plate part 126e, and is mounted to the component setting unit 150. Here, the opening 152 is formed in a portion of the component setting unit 150 corresponding to the inner plate part 126e, so that the inner plate part 126e is accommodated in the opening 152. Such a construction prevents the plate 120e from being in direct contact with the component setting unit 150, in addition to saving space by using the opening 152.

Meanwhile, the plate 120e of the touch screen device according to this embodiment may comprise a plurality of separate structures (see FIG. 3) or an integrated structure which is open therein (see FIG. 4).

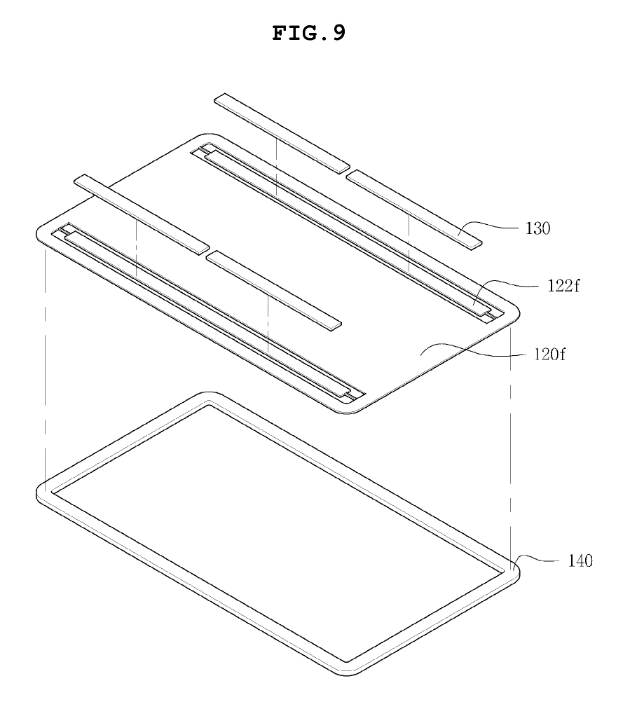

FIGS. 9 to 11 are exploded perspective views illustrating vibration generating means, plates, and elastic members of touch screen devices according to the sixth to eighth embodiments of the present invention.

As shown in FIG. 9, in the touch screen device according to the sixth embodiment, a plate includes a main plate 120f and strips 122f. The main plate 120f has the shape of a plate which is attached to the lower surface of the image display unit 114. The strips 122f are formed inside the edge of the main plate 120f. Both ends of each strip 122f are connected to the main plate 120f and a side of each strip 122f is separated from the main plate 120f.

The vibration generating means 130 are mounted on the strips 122f. Since each strip 122f has intrinsic elastic force, vibrations transmitted to the component setting unit can be minimized without an additional elastic member 140 being required. However, if necessary, the elastic member 140 may be attached to the lower surface of a portion around the edge of the main plate 120f.

Each strip 122f has no stepped structure. Hence, when the vibration generating means 130 is mounted on a strip 122f, the vibration generating means 130 may be in direct contact with the image display unit 114. However, the strips 122f which are separated at their sides from the main plate 120f perform a shaking motion like a plate spring when vibrations are applied by the vibration generating means 130. Thus, the frequency range of vibrations transmitted to the image display unit 114 can be controlled by adjusting the width, length, and thickness of the strip 122f. According to this embodiment, vibrations generated by the vibration generating means 130 are directly transmitted to the image to display unit 114 through intermittent direct contact of the vibration generating means 130 with the image display unit 114, or are transmitted through the main plate 120f connected with the strips 122f to the image display unit 114.

Preferably, both ends of each strip 122f connected to the main plate 120f are formed to be thin so as to maximize the shaking motion.

Meanwhile, the drawing illustrates an example wherein a pair of strips 122f is provided around lengthwise edges of the main plate 120f. But, the number and arrangement of the strips 122f may be altered as desired.

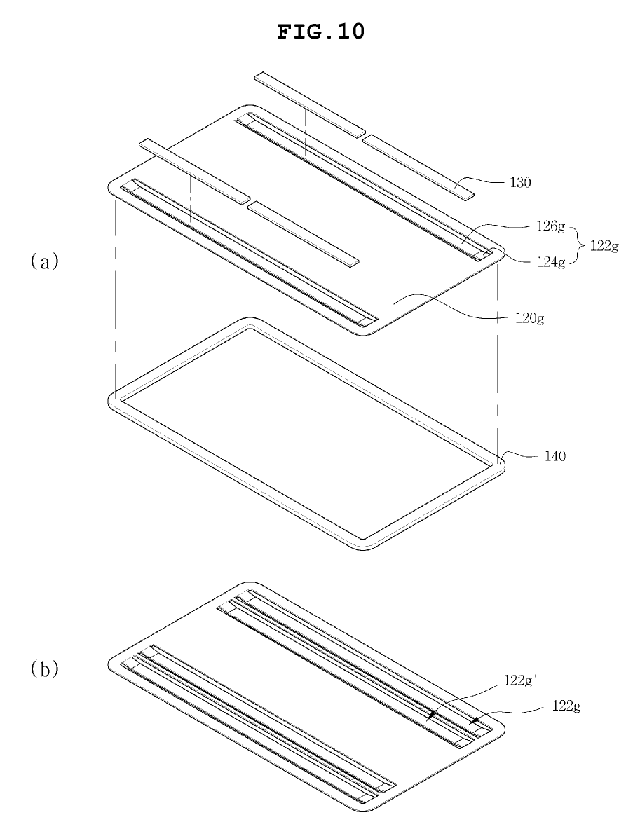

As shown in FIG. 10A, a strip 122g is formed in such a way that both ends thereof are inclined and connected to a main plate 120g. That is, the strip 122g includes inclined strip parts 124g and a horizontal strip part 126g. Both ends of the strip 122g connected to the main plate 120g are inclined downwards, thus providing the inclined strip parts 124g. The horizontal strip part 126g extends inwards from the inclined strip parts 124g in a horizontal direction. Since the strip 122g has a stepped structure, the vibration generating means 130 placed on the horizontal strip part 126g are spaced apart from the image display unit 114, and vibrations generated by the vibration generating means 130 are transmitted through the main plate 120g connected with the strip 122g to the image display unit.

As shown in FIG. 10B, a plurality of strips 122g and 122g′ may be provided.

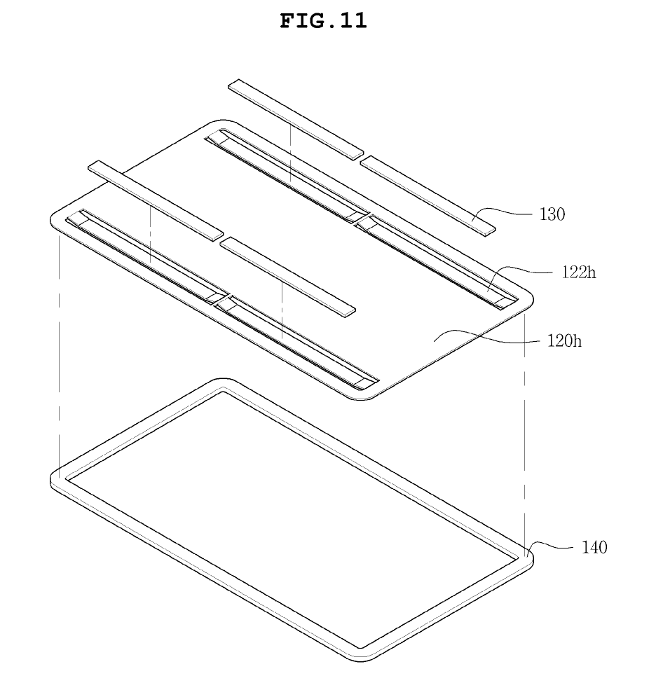

Further, as shown in FIG. 11, a plurality of strips 122h may be provided around the edge of a main plate 120h in such a way as to be separated from each other. FIG. 11 illustrates an example wherein the strips 122h are formed only around the lengthwise edges of the main plate 120h. However, the strips 122h may be formed around the widthwise edges of the main plate 120h. The arrangement should be considered to be within the scope of the present invention.

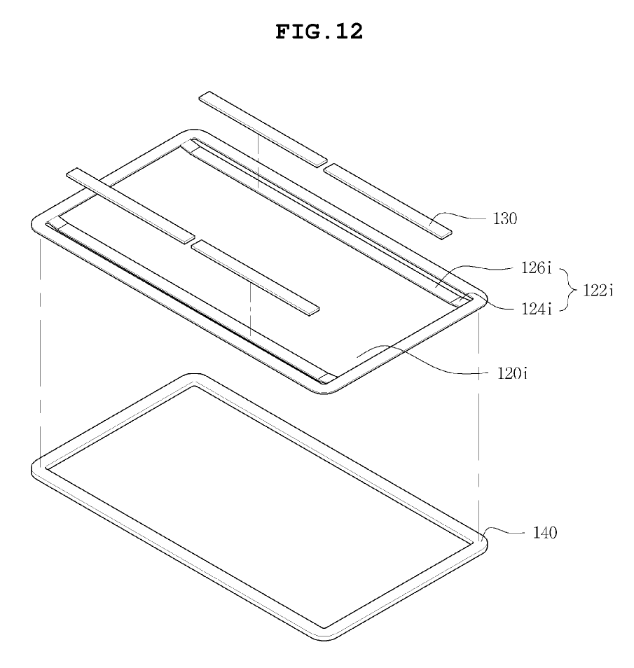

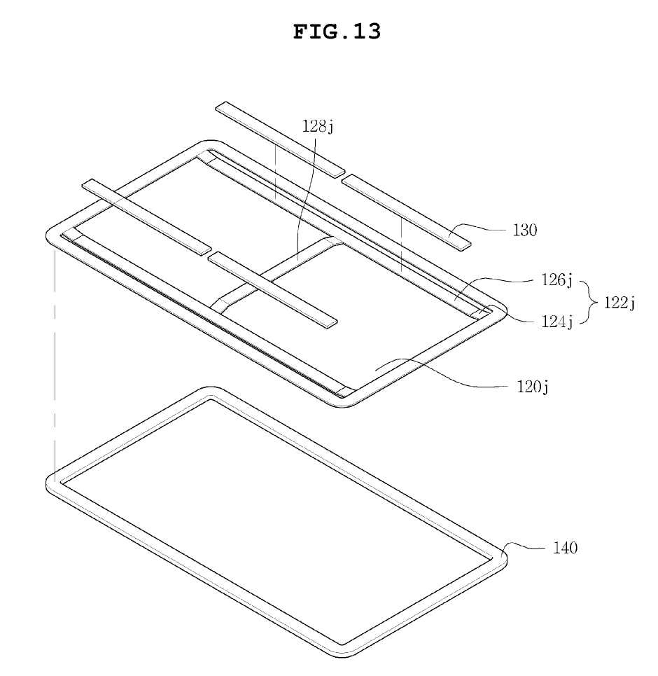

FIGS. 12 and 13 are exploded perspective views illustrating vibration generating means, plates, and elastic members of touch screen devices according to the ninth and tenth embodiments of the present invention.

First, as shown in FIG. 12, in the touch screen device according to the ninth embodiment of the present invention, the plate includes a main plate 120i and a strip 122i. The main plate 120i has the shape of a frame which is attached to the edge of the lower surface of the image display unit 114 and is open therein. The strip 122i is provided in the main plate 120i in such a way that both ends thereof are inclined and connected to the inner portion of the main plate 120i and a side of the strip 122i is separated from the main plate 120i. The touch screen device may have a plurality of strips 122i.

Next, as shown in FIG. 13, the plate 120j of the touch screen device according to the tenth embodiment of the present invention is different from the plate 120i of FIG. 12 in that a coupling strip 128j is provided to couple a pair of strips 122j to each other. The coupling strip 128j extends from opposite horizontal strip parts 126j to couple the pair of strips 122j to each other, thus allowing the strips 122j to vibrate together. In detail, the coupling strip 128j is coupled to the horizontal strip parts 126j in such a way as to be inclined upward.

As described above, the present invention provides a touch screen device, which is configured so that a vibration generating means is placed under an image display unit through a plate, thus being applicable to a touch display module which is constructed so that a touch screen panel and the image display unit are integrated into a single structure.

Further, the present invention provides a touch screen device, in which a vibration generating means is mounted to a plate in such a way as to be spaced apart from an image display unit, so that vibrations are transmitted through the plate to a touch display module, thus controlling the sensation of vibrations transmitted to the touch display module by changing the shape of the plate.

Furthermore, the present invention provides a touch screen device, in which an elastic member is provided on the lower surface of a plate to prevent the plate from being in direct contact with a component setting unit, thus increasing vibratory strength transmitted to a touch display module, and decreasing vibratory strength transmitted to the component setting unit, therefore enabling the efficient transmission of vibrations.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Accordingly, such modifications, additions and substitutions should also be understood as falling within the scope of the present invention.

What is claimed is:

1. A touch screen device, comprising:
a touch display module having a touch screen panel and an image display unit coupled to a lower surface of the touch screen panel;
at least one plate attached at a first side thereof to a portion around an edge of a lower surface of the image display unit, and stepped to extend inwards in a horizontal direction;
vibration generating means mounted on a horizontally extending portion of the plate in such a way as to be spaced apart from the image display unit; and
an elastic member attached to a lower surface of the plate.

2. The touch screen device as set forth in claim 1, wherein the plate comprises one or more pairs of plates which are mounted to lower surfaces of portions around lengthwise edges or widthwise edges of the image display unit.

3. The touch screen device as set forth in claim 1, wherein the plate comprises:
a first plate part having a shape of a frame which is attached to the portion around the edge of the lower surface of the image display unit and is open therein;
a stepped part bent downwards from the first plate part; and
a second plate part bent from the stepped part in such a way as to extend inwards in a horizontal direction.

4. The touch screen device as set forth in claim 1, wherein the plate comprises:
an outer plate part having a shape of a frame which is attached to the portion around the edge of the lower surface the image display unit and is open therein;
a bent plate part bent downwards from the outer plate part; and
an inner plate part bent from the bent plate part in such a way as to extend inwards in a horizontal direction.

5. The touch screen device as set forth in claim 1, wherein the stepped part of the plate is bent downwards from an end of the plate in such a way as to extend vertically or obliquely.

6. The touch screen device as set forth in claim 1, wherein the vibration generating means comprises a piezoelectric actuator or polymer actuator which is contracted or extended in a lengthwise direction when external power is applied so as to apply vibrations to the touch screen panel.

7. The touch screen device as set forth in claim 1, wherein the elastic member is attached to a lower surface of a predetermined portion of the plate in such a way as to protrude downwards from the plate, thus causing the plate to be spaced apart from a component setting unit.

8. The touch screen device as set forth in claim 1, wherein the elastic member is made of a rubber material.

9. The touch screen device as set forth in claim 1, wherein the elastic member attached to a lower surface of a predetermined portion of the plate is mounted to the component setting unit, and the horizontally extending portion of the plate is received in an opening formed in the component setting unit, thus causing the plate to be spaced apart from the component setting unit.

10. A touch screen device, comprising:
a touch display module having a touch screen panel and an image display unit coupled to a lower surface of the touch screen panel;
a main plate mounted to a lower surface of the image display unit;
at least one strip formed inside an edge of the main plate in such a way that both ends thereof are connected to the main plate and a side thereof is spaced apart from the main plate; and
vibration generating means mounted on an upper surface of the strip.

11. The touch screen device as set forth in claim 10, further comprising:
an elastic member attached to an edge of the main plate.

12. The touch screen device as set forth in claim 10, wherein the strip comprises:
an inclined strip part inclined downwards from the main plate; and
a horizontal strip part extending inwards from the inclined strip part in a horizontal direction.

13. The touch screen device as set forth in claim 10, wherein the strip comprises a plurality of strips provided on the main plate.

14. The touch screen device as set forth in claim 10, wherein the main plate has a shape of a frame which is open therein.

15. The touch screen device as set forth in claim 14, wherein the strip comprises one or more pairs of strips which are provided inside the edge of the main plate in such a way as to face each other, and the facing strips are coupled to each other via a coupling strip.
